(19) United States
(12) Patent Application Publication
(10) Pub. No.: US 2024/0175829 A1
(43) Pub. Date: May 30, 2024

(54) INSPECTION APPARATUS AND INSPECTION METHOD

(71) Applicant: NuFlare Technology, Inc., Yokohama-shi (JP)

(72) Inventors: Masataka SHIRATSUCHI, Yokohama-shi (JP); Riki OGAWA, Kawasaki-shi (JP); Chosaku NODA, Yokohama-shi (JP)

(73) Assignee: NuFlare Technology, Inc., Yokohama-shi (JP)

(21) Appl. No.: 18/500,367

(22) Filed: Nov. 2, 2023

(30) Foreign Application Priority Data
Nov. 22, 2022 (JP) 2022-186844

(51) Int. Cl. G01N 23/2251; G06T 7/00; G06T 7/33; G06T 7/73

(52) U.S. Cl. CPC G01N 23/2251; G06T 7/001; G06T 7/337; G06T 7/74; G06T 2207/10061; G06T 2207/30148

(57) ABSTRACT

An image acquisition circuit is configured to acquire inspection images based on secondary electrons generated by electron beams emitted to a first area of a sample on a stage. The first area includes sub areas. An estimation circuit is configured to estimate an amount of rotation of an array of the electron beams emitted to the first area based on an amount of misalignment between reference images respectively indicative of patterns to be respectively formed in the sub areas and the inspection images. The stage control circuit is configured to control, based on the amount of rotation, a focus position of the electron beams to be emitted to a second area of the sample. The comparison circuit is configured to compare the reference images with the inspection images.

### CROSS-REFERENCE TO RELATED APPLICATIONS

This application is based upon and claims the benefit of priority from Japanese Patent Application No. 2022-186844, filed Nov. 22, 2022, the entire contents of which are incorporated herein by reference.

### FIELD

Embodiments described herein relate generally to an inspection apparatus and an inspection method.

### BACKGROUND

In a manufacturing process of a semiconductor device, a pattern is transferred to a photosensitive material layer (resist) formed above a semiconductor substrate (also referred to as a “wafer”) using an exposure device, and a fine pattern of an insulator, a conductor, etc., is formed through an etching process, etc. For transfer, a mask or reticle is used. A mask has an original pattern of a pattern that is transferred to an insulator and a conductor. To form a fine pattern on the insulator and the conductor, the original pattern of the mask is also required to be fine. This requires a mask defect inspection apparatus to have a high performance in detecting defects in fine original patterns. With the miniaturization of patterns, an inspection apparatus using light such as deep ultraviolet (DUV)) light has been widely used in the past; however, from now, an inspection apparatus using extreme ultraviolet (EUV) light (actinic inspection) or electron beams is about to become mainstream.

Defect inspection may be performed by, for example, comparing an inspection image, which is based on an image by imaging the mask (captured image), with a reference image, which is based on design data that defines a pattern to be formed on the mask. The defect inspection apparatus generates the inspection image by extracting, for example, the contour line of the pattern from the captured image. The defect inspection apparatus detects a defect by comparing the contour line of the pattern of the inspection image with the contour line of the pattern of the reference image.

Imaging of a mask may use an electron beam. That is, image capturing includes emitting electron beams while scanning a mask with them and detecting secondary electrons emitted from the mask as a result of the emission of the electron beams. To perform accurate inspection, the mask needs to be imaged accurately. The surface of the mask may have a thickness that varies among various positions due to, e.g., an uneven thickness of the mask caused by polishing of the mask, deflection of the mask itself, and/or deflection that occurs when the mask is placed on a stage. For this reason, the optimal focus position may be different at each position, and defocusing may occur.

Accurate imaging of the mask requires accurate detection of the height or defocusing of the mask and appropriate adjustment of the focus position based on a result of the detection. Defocusing can be detected at a position on a z axis of the mask by a sensor that uses an optical lever, for example.

JPn. Pat. Appln. KOKAI Publication No. 2020-087788 discloses that a focus position is adjusted according to setting of an optical system of an inspection apparatus.

JPn. Pat. Appln. KOKAI Publication No. 2019-113329 and JPn. Pat. Appln. KOKAI Publication No. 2020-203760 disclose the technique relating to measurement of a mask height using an optical lever.

A sensor that uses an optical lever is difficult to handle due to its large scale. Furthermore, the detection accuracy of a sensor using an optical lever is not necessarily sufficient.

As described as a problem in JPn. Pat. Appln. KOKAI Publication No. 2020-087788, if setting of the optical system is changed for adjustment of a focus position, a captured image changes in terms of its magnification and/or rotation angle before and after the change of setting. If the magnification and/or the rotation angle change (changes) , the captured image also changes. Therefore, for acquisition of an accurate captured image, adjustment of only an optical system is not enough and many items such as the optical system, a magnification, and a rotation angle all need to be optimized.

Accordingly, there is a demand for an inspection apparatus capable of detecting a defocusing and adjusting a focus position with high accuracy using a simple device.

### BRIEF DESCRIPTION OF THE DRAWINGS

FIG. 1 shows components of an inspection apparatus according to a first embodiment.

FIG. 2 shows a configuration of a forming aperture array plate along an xy plane of the inspection apparatus according to the first embodiment.

FIG. 3 shows an example of an area of a sample to be inspected by the inspection apparatus according to the first embodiment.

FIG. 4 shows an example of a rectangular area of a sample to be inspected by the inspection apparatus according to the first embodiment.

FIG. 5 shows a flow of inspection by the inspection apparatus according to the first embodiment.

FIG. 6 shows a flow of acquisition of an inspection image by the inspection apparatus according to the first embodiment.

FIG. 7 shows a correspondence between an imaging area and a sub-rectangular area in the inspection by the inspection apparatus according to the first embodiment.

FIG. 8 shows a correspondence between two types of imaging areas in the inspection by the inspection apparatus according to the first embodiment.

FIG. 9 shows an example of vectors used to estimate rotation of an array of multiple electron-beam performed by the inspection apparatus according to the first embodiment.

FIG. 10 shows an example of a correspondence between a rotation angle and a z-coordinate correction amount acquired by the inspection apparatus according to the first embodiment.

FIG. 11 shows an example of a rectangular area of a sample inspected by an inspection apparatus according to a modification of the first embodiment.

### DETAILED DESCRIPTION

In general, according to one embodiment, an inspection apparatus includes a stage for a sample to be placed, an image acquisition circuit, an estimation circuit, a stage control circuit configured to control, and a comparison circuit. The image acquisition circuit is configured to acquire a plurality of inspection images based on secondary electrons generated by a plurality of electron beams emitted to a first area of the sample. The first area includes a plurality of sub areas. The estimation circuit is configured to estimate an amount of rotation of an array of the plurality of electron beams emitted to the first area based on an amount of misalignment between a plurality of reference images respectively indicative of patterns to be respectively formed in the plurality of sub areas and the plurality of inspection images. The stage control circuit is configured to control, based on the amount of rotation, a focus position of the plurality of electron beams to be emitted to a second area of the sample. The comparison circuit is configured to compare the plurality of reference images with the plurality of inspection images.

Embodiments will now be described with reference to the figures. In order to distinguish components having substantially the same function and configuration in an embodiment or over different embodiments from each other, an additional numeral or letter may be added to the end of each reference numeral or letter. Steps in the flow of a method according to an embodiment are not limited to any of the illustrated orders, and may occur in an order different from the illustrated orders and/or may occur concurrently with another step or other steps.

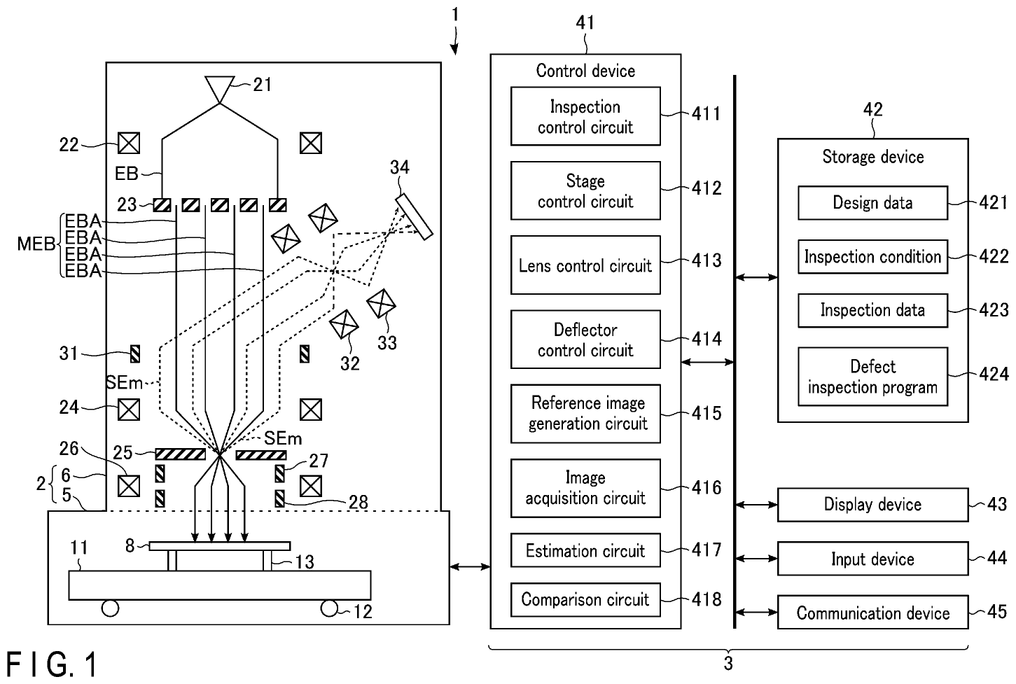

FIG. 1 shows components (a structure) of an inspection apparatus according to a first embodiment. As shown in FIG. 1, an inspection apparatus 1 includes an imaging mechanism 2 and a control mechanism 3.

The imaging mechanism 2 acquires an image of a sample 8 such as a mask or a semiconductor wafer, etc., by emitting charged particle beams (electron beams) to a sample 8 and detecting secondary electrons emitted from the sample 8. The control mechanism 3 controls the imaging mechanism 2.

The imaging mechanism 2 includes a sample chamber 5 and a lens barrel 6. The sample chamber 5 internally has a space and accommodates the sample 8 therein during inspection. The lens barrel 6 has a cylindrical shape extending perpendicular to the sample chamber 5. The lens barrel 6 is located above the sample chamber 5. Each of the sample chamber 5 and the lens barrel 6 is open at the surface on which they are in contact with each other, so that the internal space of the sample chamber 5 and the internal space of the lens barrel 6 are connected to each other. The space formed by the sample chamber 5 and the lens barrel 6 is maintained in a vacuum (reduced pressure) state using a turbomolecular pump, etc.

The inspection apparatus 1 includes a stage 11 and stage drive mechanisms 12 and 13 inside the sample chamber 5. The sample 8 is placed on the stage 11 during the inspection. While holding the sample 8 substantially horizontally, the stage 11 is capable of moving along an x axis and a y axis that are parallel to the surface of the stage 11 and are perpendicular to each other. The stage 11 is further capable of moving along a z axis perpendicular to the surface of the stage 11. The stage 11 may further be able to rotate along the xy plane about the z axis.

The stage drive mechanism 12 includes a mechanism for moving the stage 11 along the x axis and the y axis. The stage drive mechanism 12 may also include a mechanism for rotating the stage 11 along the xy plane about the z axis.

The stage drive mechanism 13 has a mechanism for moving the stage 11 along the z axis. The stage drive mechanism 13 is, for example, a piezo actuator using lead zirconate titanate (PZT).

The inspection apparatus 1 includes, within the lens barrel 6, an electron gun 21, an illumination lens 22, a forming aperture array plate 23, a reduction lens 24, a limiting aperture array plate 25, an objective lens 26, deflectors 27 and 28, a beam separator 31, projection lenses 32 and 33, and a detector 34.

Upon receipt of a voltage, the electron gun 21 emits electron beams EB downward along the z axis (−z direction). The electron beams EB spread along the xy plane as they travel along the z axis.

The illumination lens 22 is an electromagnetic lens of an annular shape and is located downward along the z axis of the electron gun 21. The illumination lens 22 changes the orientation of the trajectory of the electron beams EB which have entered the inside of the annular shape of the illumination lens 22 and have a spread on the xy plane, to the orientation parallel to the z axis.

The forming aperture array plate 23 is located on the side in the −z direction of the illumination lens 22. The forming aperture array plate 23 includes a plurality of apertures. Each aperture has, for example, a rectangular shape along the xy plane. The forming aperture array plate 23 allows some of the electron beams EB entering the forming aperture array plate 23 to pass through a plurality of apertures, thereby branching the electron beams FB into a set of a plurality of electron beams EBA. A set of electron beams EBA may be referred to as a “multiple electron-beam MEB”. Each multiple electron-beam MEB has, for example, a rectangular shape along the xy plane and proceeds substantially in parallel to the z axis. The forming aperture array plate 23 will be further described later.

The reduction lens 24 is an electromagnetic lens

of an annular shape and is located on the side in the −z direction of the forming aperture array plate 23. The reduction lens 24 focuses the multiple electron-beam MEB that have passed through the forming aperture array plate 23 on the center of the reduction lens 24.

The limiting aperture array plate 25 has a plate-like shape spreading along the xy plane and has an aperture in the center of its surface along the xy plane. The aperture is located in the vicinity of the focusing point (crossover point) of the multiple electron-beam MEB that has passed through the reduction lens 24.

The objective lens 26 is an electromagnetic lens formed into an annular shape and is located on the side in the −z direction of the reduction lens 24. The objective lens 26 focuses the multiple electron-beam MEB on the surface (upper surface) on the side in the +z direction of the sample 8.

The deflectors 27 and 28 are located on the side in the −z direction of the limiting aperture array plate 25 and are located inside the space surrounded by the objective lens 26. The deflector 28 is located on the side in the −z direction of the deflector 27. Each of the deflectors 27 and 28 includes multiple pairs of electrodes. FIG. 1 shows only one pair of electrodes to avoid unnecessary complication of the drawings. Two electrodes that make up each pair face each other. Each electrode receives a voltage, and each of the deflectors 27 and 28 deflects the multiple electron-beam MEB that has entered the deflector 27 or 28 itself, along the x axis and along the y axis in response to the application of voltage to the plurality of electrodes. In this manner, the entirety of the multiple electron-beam MEB reaches a specific area of the surface of the sample 8.

As described above, by the illumination lens 22, the forming aperture array plate 23, the reduction lens 24, the limiting aperture array plate 25, the objective lens 26, the deflector 27, and the deflector 28, the beams of the multiple electron-beam MEB arranged along the xy plane reach the surface of sample 8. In response to the sample 8 irradiated with the multiple electron-beam MEB, a set of secondary electrons (multi-secondary electrons) SEm are emitted from the sample 8. Each of the multi-secondary electrons SEm results from the irradiation of each of the multiple electron-beam MEB. Each of the multi-secondary electrons SEm is refracted by the objective lens 26 toward the center of the trajectory of the multi-secondary electrons SEm and passes through the aperture of the limiting aperture array plate 25. The multi-secondary electrons SEm that have passed through the aperture proceed in a direction substantially parallel to the z axis by the action of the reduction lens 24.

The beam separator 31 is located between the forming aperture array plate 23 and the reduction lens 24. The beam separator 31 has, for example, an annular shape. The beam separator 31 generates, inside its annular shape, an electric field and a magnetic field in directions perpendicular to each other along the xy plane. The generated electric field and magnetic field provide electrons having entered the beam separator 31 from above along the z axis (+z direction), that is, multiple electron-beam MEB with forces exerted in directions opposite to each other. For this reason, the multiple electron-beam MEB travel in the −z direction effectively without receiving forces caused by the electric field and the magnetic field. On the other hand, the electric field and the magnetic field provide electrons having entered the beam separator 31 from the −z direction, that is, multi-secondary electrons SEm with forces exerted in the same direction. For this reason, the multiple electron-beam SEm are subject to forces caused by the electric field and the magnetic field and travel in the direction at an angle with the z axis.

The projection lens 32 is an electromagnetic lens of an annular shape. The projection lens 32 is located at a position surrounding the trajectory of the multi-secondary electrons SEm that have passed through the beam separator 31 from the −z direction. That is, the line passing through the center of the annular shape of the projection lens 32 is at an angle with the z axis. The projection lens 32 changes the trajectory of the multi-secondary electrons SEm that have entered the projection lens 32.

The projection lens 33 is an electromagnetic lens of an annular shape. The projection lens 33 is located at a position surrounding the trajectory of the multi-secondary electrons SEm that have passed through the beam separator 31 from the −z direction. That is, the line passing through the center of the annular shape of the projection lens 32 is at an angle with the z axis. The projection lens 33 is aligned with the projection lens 32. The projection lens 33 changes the trajectory of the multi-secondary electrons SEm that have entered the projection lens 32.

The detector 34 is a device configured to detect received electrons. The detector 34 is located on an extension of the trajectory of the multi-secondary electrons SEm that have passed through the beam separator 31 in the −z direction. That is, the surface of the detector 34, through which the detector 34 receives electrons, is at an angle with the z axis. The detector 34 generates a signal based on the received multi-secondary electrons SEm. The signal has information for generating an image based on the received multi-secondary electrons SEm. The detector 34 includes, for example, a photodiode.

The control mechanism 3 includes a control device 41, a storage device 42, a display device 43, an input device 44, and a communication device 45. The control device 41, the storage device 42, the display device 43, the input device 44, and the communication device 45 are connected to each other via, for example, a bus, and can communicate with each other.

The control device 41 controls the entirety of the inspection apparatus 1 and inspects a defect of the sample 8. More specifically, the control device 41 acquires a secondary electronic image or a scanning electron microscope (SEM) image (captured image) by controlling the imaging mechanism 2. Furthermore, the control device 41 compares the reference image with the inspection image to detect a defect by controlling the control mechanism 3. For example, the control device 41 includes a central processing unit (CPU), a random access memory (RAM), and a read only memory (ROM) (not shown). For example, the CPU loads a program stored in the ROM or storage device 42 into the RAM. By the CPU interpreting and executing the program loaded into the RAM, the control device 41 operates. The control device 41 may be, for example, a CPU device such as a microprocessor, or a computer device such as a personal computer. Furthermore, the control device 41 may include a dedicated circuit (dedicated processor) that executes at least some functions of the control device 41. Examples of the dedicated circuit include other integrated circuits such as an application-specific integrated circuit (ASIC) , a field-programmable gate array (FPGA), a graphics processing unit (GPU), etc.

The control device 41 controls the imaging mechanism 2. The control device 41 is connected to the imaging mechanism 2 in a communicable manner. The control device 41 includes an inspection control circuit 411, a stage control circuit 412, a lens control circuit 413, a deflector control circuit 414, a reference image generation circuit 415, an image acquisition circuit 416, an estimation circuit 417, and a comparison circuit 418.

Each of the inspection control circuit 411, the stage control circuit 412, the lens control circuit 413, the deflector control circuit 414, the reference image generation circuit 415, the image acquisition circuit 416, the estimation circuit 417, and the comparison circuit 418 can be realized as hardware or computer software alone or in combination. That is, each of the inspection control circuit 411, the stage control circuit 412, the lens control circuit 413, the deflector control circuit 414, the reference image generation circuit 415, the image acquisition circuit 416, the estimation circuit 417, and the comparison circuit 418 may be realized by an integrated circuit such as an ASIC, an FPGA, etc., or may be an individual circuit controlled by an integrated circuit such as the ASIC, the FPGA, etc. Alternatively, each of the inspection control circuit 411, the stage control circuit 412, the lens control circuit 413, the deflector control circuit 414, the reference image generation circuit 415, the image acquisition circuit 416, the estimation circuit 417, and the comparison circuit 418 may be realized by a program (firmware) being executed by a CPU and/or a GPU. The inspection control circuit 411 controls the

entirety of the inspection of the sample 8. During the inspection, the inspection control circuit 411 controls the stage control circuit 412, the lens control circuit 413, the deflector control circuit 414, the reference image generation circuit 415, the image acquisition circuit 416, the estimation circuit 417, and the comparison circuit 418.

The stage control circuit 412 detects a position of the stage 11 using means such as a sensor (not shown). Furthermore, the stage control circuit 412 receives control data and controls the stage drive mechanisms 12 and 13 based on the received control data. Control data is supplied from, for example, the storage device 42, the input device 44, and/or another circuit in the control device 41. By the stage drive mechanisms 12 and 13 driving, the stage 11 and thus the sample 8 move to a desired position and height.

The lens control circuit 413 receives the control data, and based on the received control data, controls the illumination lens 22, the reduction lens 24, the objective lens 26, the beam separator 31, and the projection lenses 32 and 33. Control data is supplied from, for example, the storage device 42, the input device 44, and/or another circuit in the control device 41.

The deflector control circuit 414 receives control data and controls the deflectors 27 and 28 based on the received control data. Control data is supplied from, for example, the storage device 42, the input device 44, and/or another circuit in the control device 41.

The reference image generation circuit 415 generates a reference image based on design data 421 describing a pattern to be formed on the sample 8. That is, the reference image generation circuit 415 receives the design data 421 from the storage device 42, expands the design data 421 into data for each pattern (figure), and interprets a graphic code, graphic dimensions, etc., which are included in the expanded data and indicate a graphic shape. The reference image generation circuit 415 expands (converts) the design data 421 into a binary or multivalued (for example, 8 bits) image (expanded image) as a pattern arranged in squares in a predetermined grid. The reference image generation circuit 415 computes an occupancy indicating a rate at which the graphic occupies each pixel of the expanded image. The computed graphic occupancy in each pixel functions as a gradation value for the pixel concerned. The reference image generation circuit 415 extracts a contour of a pattern of the expanded image based on the gradation values of the respective pixels and generates a reference image (contour image). The reference image generation circuit 415 transmits the generated reference image to the comparison circuit 418 and the storage device 42.

The image acquisition circuit 416 acquires a secondary electronic image of the sample 8 by controlling the imaging mechanism 2. The image acquisition circuit 416 controls the imaging mechanism 2 based on control data. Control data is supplied by, for example, the storage device 42 and/or the input device 44, and/or is generated by the image acquisition circuit 416. For the acquisition of the secondary electronic image, the image acquisition circuit 416 supplies control data to the stage control circuit 412, the lens control circuit 413, and the deflector control circuit 414 for the control of each of the stage control circuit 412, the lens control circuit 413, and the deflector control circuit 414. The image acquisition circuit 416 receives data on the secondary electronic image from the detector 34. The image acquisition circuit 416 generates an inspection image (contour image) by extracting contour data from the data on the secondary electronic image. The contour data includes information on contour points of a pattern and a contour line connecting the contour points. In other words, the contour data includes a representative value of the coordinates through which the contour line passes for each pixel, that is, a contour point, and information on a normal direction of a contour vector at the contour point. The image acquisition circuit 416 transmits the generated inspection image to the comparison circuit 418 and the storage device 42.

The estimation circuit 417 estimates the amount (angle) of rotation of an array of multiple electron-beam MEB that have reached the sample 8, based on a reference position of the electron beam EBA of the multiple electron-beam MEB and a position of each of the electron beams EBA of the multiple electron-beam MEB that have reached the sample 8 for acquisition of the inspection image.

The comparison circuit 418 detects a defect by comparing the inspection image with the reference image. More specifically, the comparison circuit 418 performs alignment between the inspection image and the reference image, thereby calculating the amount of misalignment of the inspection image with respect to the reference image. Alignment of the inspection image and the reference image includes moving the inspection image in such a manner as to minimize the difference between the inspection image and the reference image, by using a method of evaluating image matching (pattern matching evaluation method). Examples of the pattern matching evaluation method include a sum of squared difference (SSD).

The comparison circuit 418 calculates a distortion coefficient by measuring the amount of distortion in the inspection image based on, for example, a variation in the amount of shift within the plane of the sample 8, etc. For example, the amount of distortion is expressed by a polynomial model of the coordinates (x, y) within the image, and the distortion coefficient is used as a coefficient of the polynomial. The comparison circuit 418 compares the inspection image with the reference image using an appropriate algorithm in with the amount of shift and the distortion coefficient considered. In the case where a discrepancy between the inspection image and the reference image exceeds a preset value, the comparison circuit 418 determines that a defect is present in the position of the sample 8, at which the discrepancy occurs.

The storage device 42 is a device including a storage medium that stores data and programs relating to defect inspection. The storage device 42 includes a RAM and a ROM. The storage device 42 may include, as an external storage, various storage devices such as a magnetic disk storage device (hard disk drive: HDD), a solid state drive (SSD), etc. The storage device 42 may include, for example, a drive for reading a program stored in a non-transitory storage medium such as a compact disc (CD) or a digital versatile disc (DVD).

The storage device 42 stores design data 421, an inspection condition 422 that specifies inspection parameters, and inspection data 423. Examples of parameters of the inspection condition 422 include an imaging condition for the imaging mechanism 2, a reference image generation condition, a secondary electron image contour extraction condition, and a defect detection condition. The inspection data 423 includes image data (the expanded image, the reference image, the secondary electronic image, and the inspection image) and data (the coordinates and size, etc.) on a detected defect.

The storage device 42 stores the defect inspection program 424. The defect inspection program 424 is a program for causing the control device 41 to perform defect inspection.

The display device 43 includes a display screen such as a liquid crystal display (LCD) or an electroluminescence (EL) display. The display device 43 displays information such as a defect detection result under control of the control device 41.

The input device 44 is an input device such as a keyboard, a mouse, a touch panel, or a button switch.

The communication device 45 is a device for connecting the inspection apparatus 1 to a network in order to perform transmission and reception of data between the inspection apparatus 1 and a device external thereto. For such communications, various communication standards may be used. For example, the communication device 45 receives design data from the external device and transmits, e.g., a result of the defect inspection to the external device.

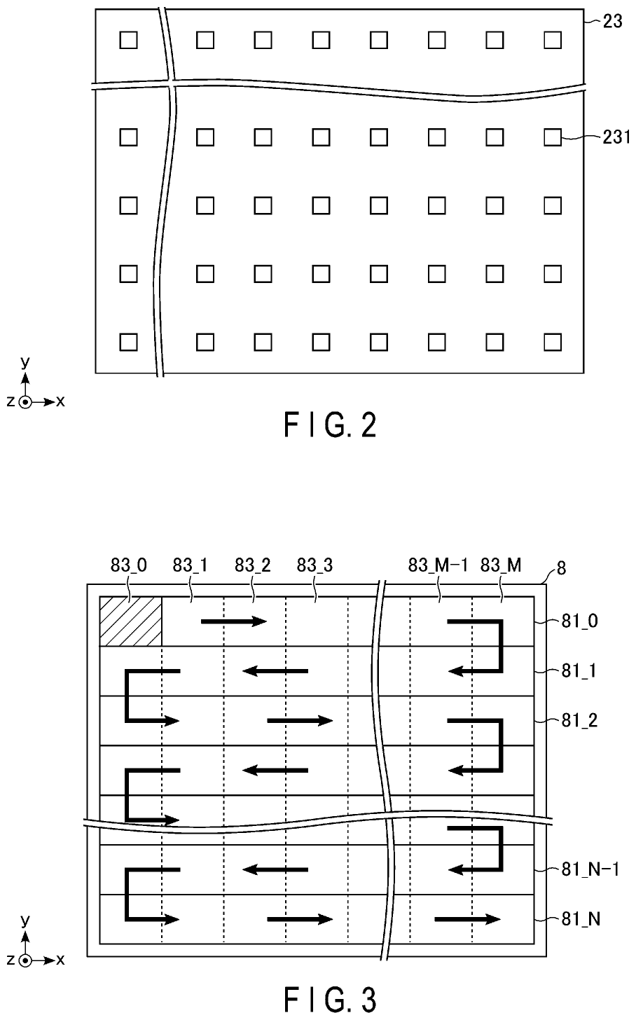

FIG. 2 shows a structure of the forming aperture array plate 23 of the inspection apparatus 1 according to the first embodiment, along the xy plane. As shown in FIG. 2, the forming aperture array plate 23 spreads along the xy plane and has a rectangular shape, for example. The forming aperture array plate 23 includes, for example, silicon with its surface covered with a thin film. The forming aperture array plate 23 has a plurality of apertures 231. Each of the apertures 231 penetrates two opposing surfaces along the z axis of the forming aperture array plate 23. The apertures 231 are arranged in a matrix form along the x axis and the y axis, for example. The apertures 231 are each formed into a square shape and have substantially the same shape.

The electron beam EB injected from the electron gun 21 is shaped by the illumination lens 22 so as to be parallel to the z axis and enters the upper surface of the forming aperture array plate 23. Part of the electron beams EB that have entered the upper surface are shielded by the forming aperture array plate 23, and the rest of them pass through the apertures 231. By selective shielding and passage of the electron beams EB described above, the electron beams EB are divided (multiplied) into a plurality of sets of electron beams EBA (multiple electron-beam) traveling in the −z direction.

FIG. 3 shows an example of an area of the sample 8 to be inspected by the inspection apparatus 1 according to the first embodiment. The sample (mask) 8 has a pattern (not shown). As shown in FIG. 3, the area as an inspection target in the sample 8 has a plurality of stripes 81 and is virtually divided into the plurality of stripes 81. FIG. 3 shows an example in which the sample 8 has N+1 stripes 81_0 to 81_N. N is a positive odd number. Each of the stripes 81 has a quadrilateral shape extending along the x axis and they are distributed over the xy plane of the sample without overlapping each other. The stripes 81_0 to 81_N are arranged in this order in the direction (−y direction) of a smaller coordinate value on the y axis. Each of the stripes 81 extends up to the vicinities of the two ends (left and right ends) aligned along the x axis of sample 8. The stripes 81 aligned along the y axis are in contact with each other.

Each of the stripes 81 consists of a plurality of rectangular areas 83 and is virtually divided into the plurality of rectangular areas 83. FIG. 3 shows an example in which each of the stripes 81 has M+1 rectangular areas 83_0 to 83_M. M is a positive integer. The rectangular areas 83_0 to 83_M are arranged in this order in the direction toward a larger coordinate value on the x axis (+x direction) . Image acquisition of the sample 8 is performed for each rectangular area 83, and the images of all the rectangular areas 83 are acquired one by one through scanning. FIG. 3 shows an example of the order of acquiring the images of the rectangular areas 83, as indicated by the thick lines. First, an image of a stripe 81_0 is acquired. That is, images of the rectangular areas 83_m of the stripe 81_0 are acquired sequentially in ascending order of m. Herein, m is an integer greater than or equal to 0 and smaller than or equal to M. Next, an image of the stripe 81_1 is acquired. That is, images of the rectangular areas 83_m of the stripe 81_1 are acquired sequentially in descending order of m. Hereinafter, images are acquired in the order of stripes 81_2 to 81_N in a similar manner. With n as an integer greater than or equal to 0 and smaller than or equal to N, in a stripe 81_n where n is an even number, images of rectangular areas 83_m are acquired sequentially in ascending order of m. That is, the direction of image acquisition is the +x direction. In a stripe 81_n where n is an odd number, images of rectangular areas 83_m are acquired sequentially in descending order of m. That is, the direction of image acquisition is the −x direction.

Changing of the rectangular area 83 targeted for

image acquisition is conducted by relative movement caused by movement of the stage 11. That is, in the case of the direction of image acquisition being the +x direction, the stage 11 moves in the −x direction, and in the case of the direction of image acquisition being the −x direction, the stage 11 moves in the +x direction.

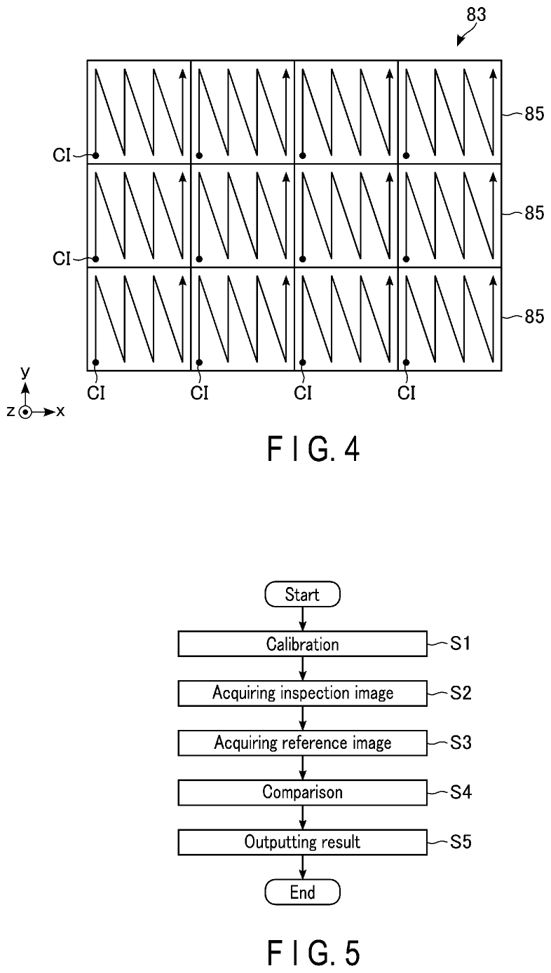

FIG. 4 shows an example of the rectangular area 83 of the sample 8 to be inspected by the inspection apparatus 1 according to the first embodiment. As shown in FIG. 4, each of the rectangular areas 83 consists of I sub-rectangular areas 85 and is virtually divided into the I sub-rectangular areas 85. Herein, I is an integer greater than or equal to 2. FIG. 4 shows an example of I being 12. The sub-rectangular areas 85 extend over the xy plane without overlapping each other. The sub-rectangular areas 85 are arranged in a matrix form along the x axis and the y axis. As an example, four sub-rectangular areas 85 are aligned along the x axis and three sub-rectangular areas 85 are aligned along the y axis. The adjacent sub-rectangular areas 85 are in contact with each other.

In order to acquire an image of the rectangular area 83, the inspection apparatus 1 performs scanning on the rectangular area 83 with the multiple electron-beam MEB. Different electron beams EBA of the multiple electron-beam MEB are emitted toward the plurality of different sub-rectangular areas 85. Scanning operations on all the sub-rectangular areas 85 in the single rectangular area 83 are performed in parallel (simultaneously). In one emission (shot) of the multiple electron-beam MEB, the plurality of electron beams EBA are emitted to the same positions among the plurality of sub-rectangular areas 85. Each time the shot is repeated, the position to which each multiple electron-beam MEB is emitted is changed. By repeatedly changing the emission position of the multiple electron-beam MEB for every shot, a trajectory of the emission position is formed. An example of the trajectory of the emission position is indicated by an arrow. For example, each electron beam EBA is first emitted to a position CI corresponding to the smallest coordinate values on the x axis and the y axis of the sub-rectangular area 85 targeted for emission of the electron beam EBA. The respective electron beams EBA are then emitted sequentially from the position CI in the direction toward a larger coordinate value on the y axis (+y direction). The electron beams EBA are then emitted sequentially at the position in the +x direction from the end of the side in the −y direction toward the side in the +y direction. Similarly, sequential emission from the end of the side in the −y direction to the side in the +y direction is performed sequentially on the side further in the +x direction. Upon completion of the sequential emission in the +y direction at the end of the side in the +x direction, scanning on the rectangular area 83 is completed, and an image of the rectangular area 83 is acquired in this way.

By combining all the images of the rectangular area 83 acquired by the method described above with reference to FIGS. 3 and 4, an image of the inspection area of the sample 8 is acquired.

FIG. 5 shows a flow of inspection by the inspection apparatus 1 according to the first embodiment. The flow of FIG. 5 is performed under control of the inspection control circuit 411. As shown in FIG. 5, the inspection control circuit 411 executes calibration by controlling the imaging mechanism 2 (S1). Through the calibration, a gradation value of the secondary electronic image to be acquired in the image acquisition circuit 416 is adjusted.

The inspection control circuit 411 acquires an inspection image of the sample 8 (S2). The acquired inspection image is transmitted to the comparison circuit 418.

The reference image generation circuit 415 generates a reference image from the design data 421 (S3). More specifically, the reference image generation circuit 415 reads the design data 421 stored in the storage device 42 and expands the read design data 421 into the expanded image. The reference image generation circuit 415 generates a reference image from the generated expanded image.

The comparison circuit 418 performs comparison (S4). More specifically, the comparison circuit 418 first executes alignment between an inspection image and a reference image, and then performs alignment between a pattern in the inspection image and a pattern in the reference image. Next, the comparison circuit 418 compares the inspection image with the reference image. The comparison circuit 418 calculates the difference between contour positions respectively included in the inspection image and the reference image, and determines that there is a defect in a pixel in which the aforementioned difference is greater than or equal to a preset threshold value.

The inspection control circuit 411 outputs a comparison result (inspection data) (S5). The inspection control circuit 411 stores an inspection result in the storage device 42. The inspection control circuit 411 causes the display device 43 to display thereon the inspection result or may output it to an external device (for example, a review device) via the communication device 45.

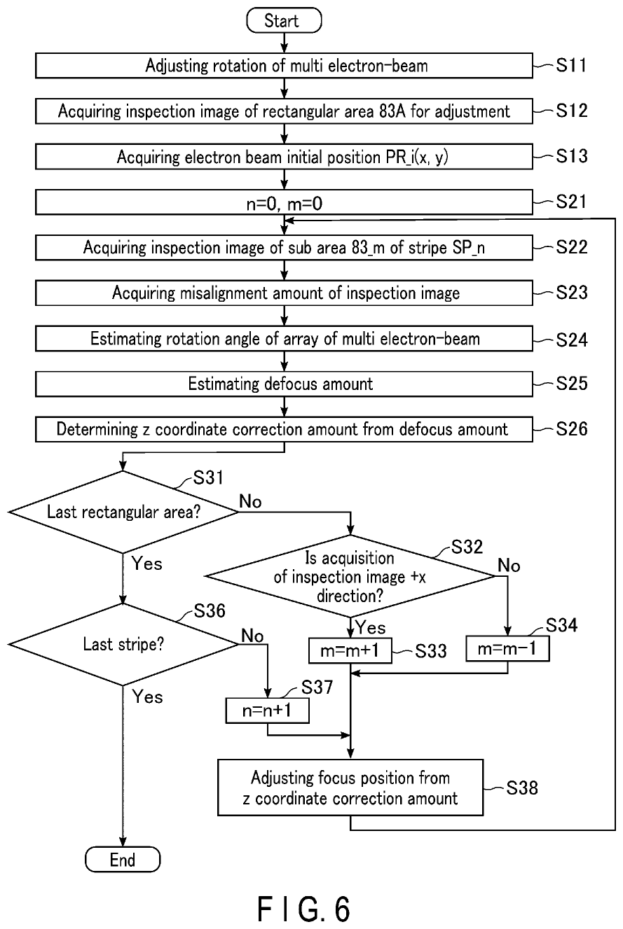

FIG. 6 shows a flow of acquisition of an inspection image by the inspection device 1 according to the first embodiment. FIG. 6 shows a flow of details of step S2 in the flow of FIG. 5.

As shown in FIG. 6, the inspection control circuit 411 adjusts the rotation of the array of the multiple electron-beam MEB (S11). That is, the inspection control circuit 411 adjusts the optical system (the illumination lens 22, the reduction lens 24, the objective lens 26, etc.) in such a manner as to minimize the rotation of the multiple electron-beam MEB and to match a focus.

As shown in FIG. 6, the inspection control circuit 411 controls the image acquisition circuit 416 to acquire an inspection image of the rectangular area 83 for adjustment (the rectangular area 83A for adjustment) using the multiple electron-beam MEB (S12) . The rectangular area 83A for adjustment may be, for example, the first rectangular area 83_0 of the first stripe 81_0.

Alternatively, in the case where the first rectangular area 83_0 of the first stripe 81_0 does not contain a necessary pattern (such as the case in which an area to be scanned with a specific beam contains no pattern), the rectangular area 83A for adjustment may be any rectangular area 83 in which a pattern dedicated to adjustment is formed.

The inspection control circuit 411 performs alignment between the inspection image acquired in step S12 and the reference image acquired from the design data that defines the pattern of the rectangular area 83A for adjustment, thereby acquiring all of the positions (coordinates) which the respective electron beams EBA emitted in parallel to all the sub-rectangular areas 85 of the rectangular area 83A for adjustment have reached in the first shot (S13). Specifically, the step is performed as follows.

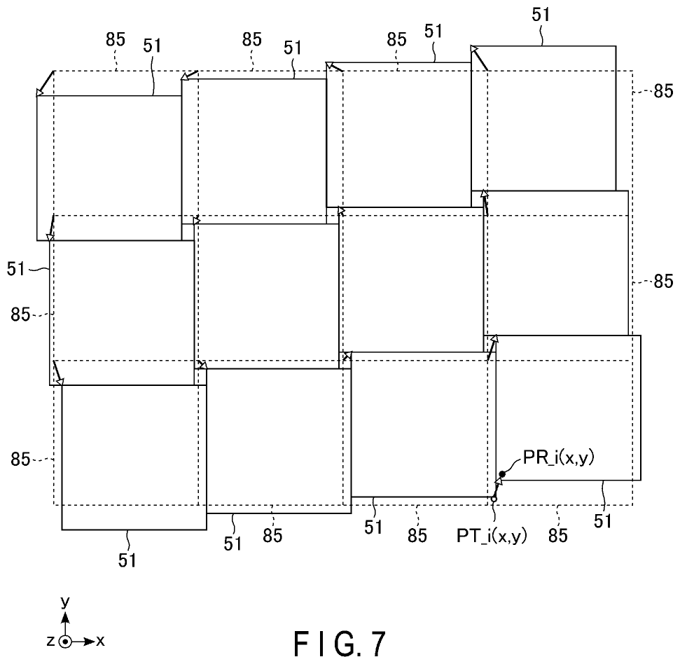

As shown in FIG. 7, the area (imaging area) 51 in which the secondary electron image was acquired may deviate from the sub-rectangular area 85, which is originally the area in which the image should be acquired. A direction and a magnitude of a deviation are indicated by arrows. Each arrow indicates a deviation between a sub-rectangular area 85 and the imaging area 51 in which an image is acquired by the electron beam EBA for imaging the sub-rectangular area 85 concerned. An arrow, i.e., a direction and a position of a deviation, can be represented as a vector. In the case where there is a deviation between the inspection image of the rectangular area 83A for adjustment and the corresponding reference image, the shape of the inspection image is different from the shape of the reference image acquired from the design data that defines the pattern of the rectangular area 83A for adjustment. Hereinafter, a reference image acquired from the design data that defines a pattern of a target area in which a certain inspection image was acquired, that is, an area to which the multiple electron-beam MEB was directed for acquisition of the inspection image, will be referred to as a “corresponding reference image”.

The inspection control circuit 411 causes the comparison circuit 418 to perform alignment between the inspection image and the corresponding reference image.

That is, the inspection control circuit 411 causes the comparison circuit 418 to determine the amount of movement of the inspection image to realize the minimum deviation from the corresponding reference image while sequentially changing the position of the inspection image. In this manner, the amount of movement of the inspection image for minimizing a deviation between the inspection image and the reference image is acquired. The amount of movement is the amount of deviation (amount of misalignment) between the area in which the inspection image was acquired and the rectangular area 83A for adjustment, and is a two-dimensional vector consisting of the amount of misalignment on the x axis and the amount of misalignment on the y axis.

As shown in FIG. 7, the generated inspection image being deviated from the corresponding reference image means that the position (coordinates) PR (x, y) at which the multiple electron-beam MEB used to acquire the inspection image has reached the rectangular area 83A for adjustment is deviated from the position PT (x, y) the multiple electron-beam MEB used to acquire the inspection image should reach if there is no deviation (rotation). Therefore, the amount of misalignment between the area in which the inspection image was acquired and the rectangular area 83A for adjustment represents a deviation from the position PT (x, y) each electron beam EBA should originally reach. Accordingly, from the sum of the position (coordinates) PT (x, y) the electron beam EBA should originally reach in the case of having no deviation (rotation) and the amount of misalignment, the position (coordinates) PT (x, y) each electron beam EBA of the multiple electron-beam MEB has reached in the first shot used for acquisition of the inspection image of the rectangular area 83A for adjustment is determined. Hereinafter, the position PR (x, y) will be referred to as an “electron beam initial position PR (x, y)”. Components x and y are respectively coordinates on the x axis and on the y axis of the electron beam initial position PR (x, y). As a result of step S13, the electron beam initial position PR (x, y) in each sub-rectangular area 85 of the rectangular area 83A for adjustment is acquired. The electron beam initial position PR (x, y) in a certain sub-rectangular area 85 i of the rectangular area 83A for adjustment will be referred to as an “electron beam initial position PR_i (x, y)”. Herein, i is an integer greater than or equal to 0and smaller than or equal to I. As a result of step S13, the electron beam initial position PR i (x, y) is acquired for all cases in which i is an integer greater than or equal to 0 and smaller than or equal to I. The inspection control circuit 411 sets the

variables n and m to 0 (S21).

The inspection control circuit 411 controls the image acquisition circuit 416, thereby acquiring the inspection image of the rectangular area 83_m of the stripe SP_n using the multiple electron-beam MEB (S22).

Hereinafter, the inspection image of the rectangular area 83_m of the stripe SP_n may be referred to as an “inspection image IM_n m”.

The inspection control circuit 411 performs alignment between the inspection image IM_n_m and the corresponding reference image to acquire the amount of misalignment of the inspection image IM_n_m (S23). That is, the inspection control circuit 411 uses the comparison circuit 418 to acquire the amount of movement of the inspection image IM_n_m that minimizes the deviation between the inspection image IM_n_m and the corresponding reference image. The amount of movement is the amount of deviation (amount of misalignment) from the sub-rectangular area 85 of the area in which the inspection image was acquired, and is a two-dimensional vector consisting of the amount of misalignment on the x axis and the amount of misalignment on the y axis.

The inspection control circuit 411 acquires the position (coordinates) of each electron beam EBA that has reached the rectangular area 83_m of the stripe SP_n in the first shot, by the same principle as that described above for step S13. In a certain sub-rectangular area 85_i in the rectangular area 83_m of the stripe SP_n, the position to which each electron beam EBA has reached, which is obtained in step S13, will be referred to as an “electron beam position PS_i (x, y)”. Components x and y respectively correspond to coordinates on the x axis and the y axis of the electron beam position PS_i (x, y). As a result of step S23, the electron beam position PS_i (x, y) is acquired for all cases in which i is an integer greater than or equal to 0 and smaller than or equal to I.

The inspection control circuit 411 uses the electron beam initial position PR_i (x, y) and the electron beam position PS_i (x, y) to estimate the rotation angle of the array of multiple electron-beam MEB that has reached the rectangular area 83_m of the stripe SP_n (S24). Estimation of the rotation angle of the array of multiple electron-beam MEB will be given later in detail.

The inspection control circuit 411 uses the estimation circuit 417 to estimate the amount of defocusing (height of the surface of the sample 8) at the time of acquisition of the secondary electron image of the rectangular area 83_m of the stripe SP_n from the rotation angle (S25). The array of multiple electron-beam MEB may be rotated by the strong magnetic field of the objective lens 26. In response to the array of multiple electron-beam MEB rotating, the focus depth (position) of each electron beam EBA of this multiple electron-beam MEB changes. Thus, the amount of defocusing with respect to the rectangular area 83_m of the stripe SP_n can be determined from the rotation angle.

The inspection control circuit 411 determines the amount of correction (the amount of z coordinate correction) for the z coordinate of the sample 8 from the amount of defocusing (S26). The defocusing can be reduced by adjusting the z coordinate of the sample 8. Therefore, from the amount of defocusing, the amount of correction of the z coordinate that substantially cancels the amount of defocusing can be determined. The method of determining the amount of z coordinate correction will be given later in detail. The amount of z coordinate correction is used to adjust the position of the focus outside of the rectangular area 83_m of the stripe SP_n.

The inspection control circuit 411 determines

whether or not the rectangular area 83_m is the rectangular area 83 in which the amount of z coordinate correction was last estimated in the stripe SP_n (S31). That is, the inspection control circuit 411 determines whether or not the inspection images of all the rectangular areas 83_m in the stripe SP_n have been acquired. For example, the inspection control circuit 411 counts the number of inspection images acquired in the current stripe SP, and can determine, in the case where the counting result is M, that inspection images of all the rectangular areas 83_m have been acquired. Alternatively, the inspection control circuit 411 determines that the inspection images of all the rectangular areas 83_m have been acquired under the condition of m=M in the case where the variable n is an even number, and under the condition of m=0 in the case where the variable n is an odd number.

In the case where the rectangular area 83 concerned is not the last one (S31 No), the inspection control circuit 411 determines whether or not the inspection image is sequentially acquired in the +x direction in the current stripe SP (stripe SP_n) (S32). For example, in the case where the variable n is an even number, the inspection control circuit 411 can determine that the inspection images are acquired sequentially in the +x direction. On the other hand, in the case where the variable n is an odd number, the inspection control circuit 411 can determine that the inspection images are sequentially acquired in the −x direction.

In the case where the inspection images are sequentially acquired in the +x direction (S32 Yes), the inspection control circuit 411 increments the variable m by one to establish m=m+1 (S33). In the case where the inspection images are not sequentially acquired in the +x direction (S32_No), the inspection control circuit 411 decrements the variable m by 1 to establish m=m−1 (S34).

In the case where the rectangular area 83 concerned is the last one (S31_Yes), the inspection control circuit 411 determines whether or not the stripe SP_n is the stripe SP from which the inspection image was last acquired (S36). That is, the inspection control circuit 411 determines whether or not the inspection images of all the strips SP have been acquired. For this purpose, for example, the inspection control circuit 411 can determine whether or not n=N is true. In the case where the inspection image of the last stripe SP is already acquired (S36_Yes), the processing is terminated. In the case where the inspection image of the last stripe SP is not yet acquired (S36_No), the inspection control circuit 411 increments the variable n by one to establish n=n+1 (step S37).

Steps S33, S34, and S37 are continuous to step S38. As step S38, the inspection control circuit 411 adjusts the amount of focus of the multiple electron-beam

MEB for acquisition of the inspection image of the rectangular area 83_m of the stripe SP_n (S38). For adjustment, the amount of z coordinate correction estimated for the rectangular area 83 other than the rectangular area 83_m of the stripe SP_n is considered. For example, the inspection control circuit 411 uses the amount of z coordinate correction for the rectangular area 83_m of the stripe SP_n−1. More specifically, the inspection control circuit 411 adds the amount of z coordinate correction for the rectangular area 83_m of the stripe SP_n−1 to the focus position (z coordinate) predetermined for the rectangular area 83_m of the stripe SP_n. The z coordinate equal to the sum thus acquired is used during the acquisition of the inspection image of the rectangular area 83_m of the stripe SP_n. The amount of z coordinate correction for a rectangular area 83_m other than that of the previous stripe SP_n−1 may be added. Furthermore, the amount of z coordinate correction for the previous rectangular area 83 may be added for the adjustment of the focus position predetermined for the rectangular area 83_m of the stripe SP_n. For example, in the case where the inspection images are acquired sequentially in the +x direction, the amount of z coordinate correction for the rectangular area 83_m−1 of the stripe SP_n is added, and in the case where the inspection images are acquired sequentially in the −x direction, the amount of z coordinate correction for the rectangular area 83_m+1 of the stripe SP_n is added. Step S38 is continuous to step S22.

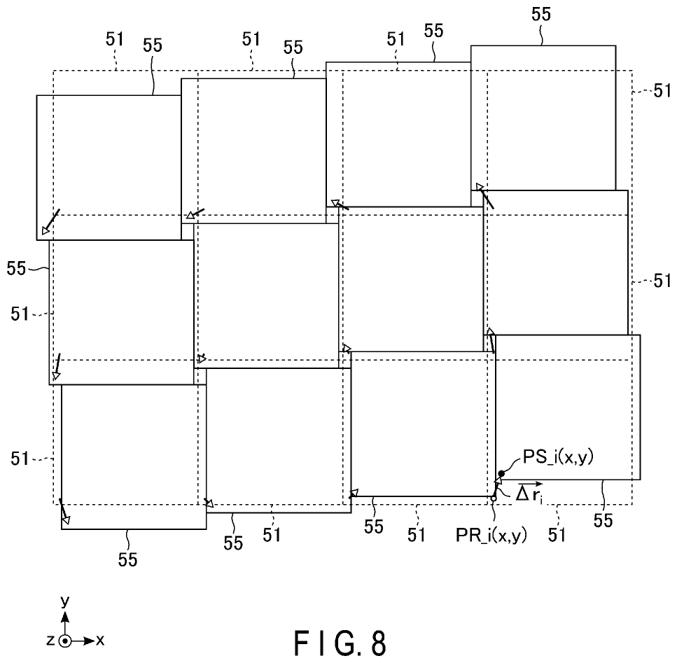

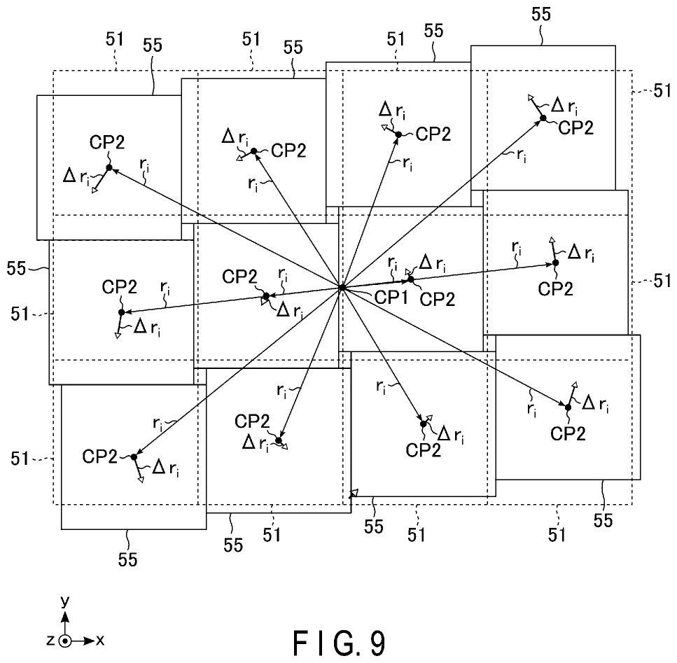

Referring to FIG. 8 and FIG. 9, the estimation of the rotation angle performed as step S24 will be described. FIG. 8 shows the correspondence between two types of imaging areas in the inspection by the inspection apparatus 1 according to the first embodiment, that is, the imaging area for the rectangular area 83A for adjustment and the imaging area for the rectangular area which is an estimation target. As shown in FIG. 8 and as described above with reference to FIG. 6, at the beginning of step S24, the electron beam initial position PR_i (x, y) and the electron beam position PS_i (x, y) for each electron beam EBA have already been acquired. Each area 55 in FIG. 8 is a imaging area in which the electron beam position PS_i (x, y) has been acquired, and is located, because of the rotation of the array of the multiple electron-beam MEB, at a position different from that of each imaging area 51 in which the electron beam initial position PR_i (x, y) is acquired.

From the electron beam initial position PR_i (x, y) and the electron beam position PS_i (x, y), as shown in FIG. 8, the vector

\vec{Δη}

from the electron beam initial position PR_i to the electron beam position PS_i (x, y) for each electron beam EBA (x, y) is acquired. The vector

\vec{Δη}

can function as a vector indicative of a deviation from the coordinates that the entire array of multiple electron-beam emitted toward the sub-rectangular area 85_i should reach (i.e., a deviation between each imaging area 51 and each area 55).

FIG. 9 shows an example of vectors used to estimate the rotation of the array of multiple electron-beam performed by the inspection apparatus 1 according to the first embodiment. As shown in FIG. 9, a center point CP1 is defined. Herein, it is assumed that the center point CP1 corresponds to a point on which a so-called “optical axis” of an optical system penetrates the surface (upper surface) of the sample 8, and is adjusted to coincide with the set of center points of all (in the current example, 12) imaging areas 51. Furthermore, for all cases in which i is greater than or equal to 0 and smaller than or equal to I, the vector

\vec{rᵢ}

from the center point CP1 to the center point CP2 of each area 55 is obtained. FIG. 9 also shows the vector

\vec{Δrᵢ}

indicative of a deviation between each imaging area 51 and each area 55 described above with reference to FIG. 8, as a vector whose starting point is each center point CP2.

Equation 1 calculates the rotation angle θᵢ for each electron beam EBA.

$$sin Δ {θ}_{i} = \frac{\vec{{r}_{i}} \times ( \vec{Δ {r}_{i}} - \frac{1}{I} {\sum }_{i} \vec{Δ {r}_{i}} )}{\vert \vec{{r}_{i}} \vert \cdot \vert \vec{Δ {r}_{i}} - \frac{1}{I} {\sum }_{i} \vec{Δ {r}_{i}} \vert} \qquad ( Equation 1 )$$

By Equation 2, the average of the rotation angles θᵢ of the respective electron beams EBA is calculated as the rotation angle Δθ of the array of multiple electron-beam MEB.

Δθ=1/IΣᵢΔθᵢ

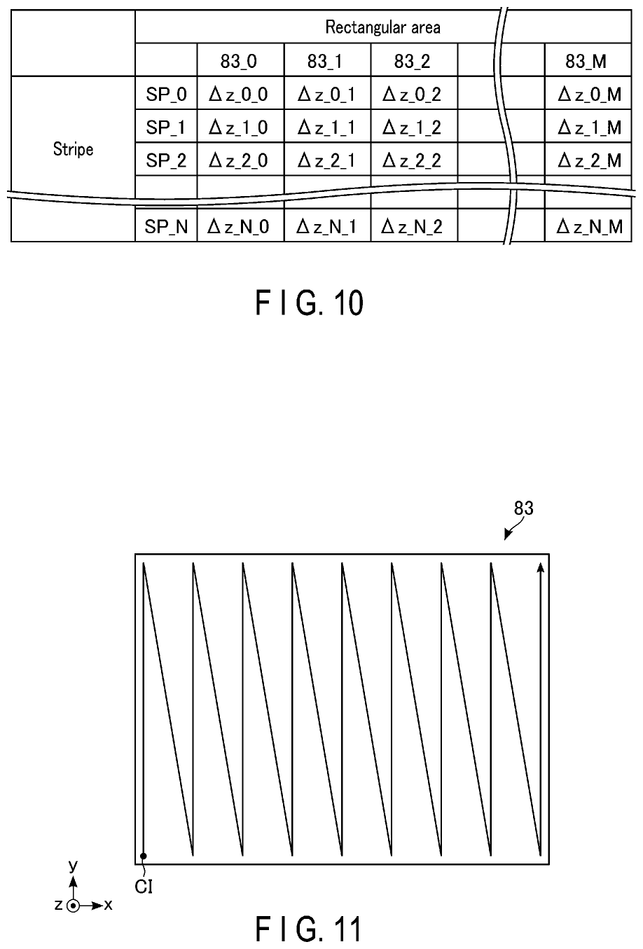

Referring to FIG. 10, the rotation angle and the amount of z coordinate correction of the array of the multiple electron-beam MEB will be described. FIG. 10 shows an example of the correspondence between the rotation angle and the amount of z coordinate correction acquired by the inspection apparatus 1 according to the first embodiment. The rotation of the array of multiple electron-beam MEB causes defocusing of each electron beam EBA. The rotation angle and the amount of defocusing are in a proportional relationship based on the magnitude of the magnetic field of the objective lens 26, the distance from the center of the array of the multiple electron-beam MEB of the respective electron beams EBA, the charge of electrons, the mass of electrons, etc. Thus, the defocusing can be corrected by adjusting the z coordinate of the sample 8, that is, the amount of defocusing corresponds, on one-to-one basis, to the amount of z coordinate correction Δz that only substantially cancels the amount of defocusing. Accordingly, the rotation angle Δθ and the amount of z coordinate correction Δz are determined. The amount of z coordinate correction Δz can be calculated from the rotation angle Δθ by Equation 3.

$$Δ z = \frac{Δ θ}{\sqrt{\frac{e}{8 {m}_{e} Φ}} B} \qquad ( Equation 3 )$$

Herein, e is the amount of charge of the electron, mₑ is the mass of the electron, Φ is the electric field potential, and B is the magnetic field caused by the objective lens 26.

As described above with reference to FIG. 6,

every time each inspection image is acquired, the amounts of z-coordinate correction for each rectangular area 83 are acquired one after another. Therefore, as shown in FIG. 10, the amounts of z coordinate correction Δz_n_m for each rectangular area 83_m of the stripe SP_n are acquired one after another in parallel with the acquisition of the inspection image.

According to the first embodiment, the amount of defocusing can be detected with high accuracy. The accuracy of detecting the amount of defocusing using a general sensor using an optical lever is about several hundred nm. On the other hand, the accuracy according to the first embodiment is as follows. As an example, the misalignment along the circumferential direction due to the rotation of the array of multiple electron-beam MEB is represented by Δθ=515.8×Δz, where B=0.11 [T] and Φ=1000 [eV]. As an example, in the case where a spacing between the electron beams EBA of the multiple electron-beam MEB that has reached the sample 8 is 9 [μm], and the multiple electron-beam MEB includes the electron beams EBA arranged in the form of 11×11, the distance from the center of each electron beam EBA at the corner of the array of the multiple electron-beam MEB is 63.6 [μm]. As an example, suppose that the size of one pixel is 7 [nm]×7 [nm], and that 0.1 pixel misalignment can be detected by an SSD. In this case, it is possible to detect a rotation of 0.7 [nm]/63.6 [μm]≈11 [μrad]. Therefore, the amount of defocusing in the case of Δθ being 11 [μrad], that is, the amount of z coordinate correction Δz, is about 21 nm. This is significantly higher than the accuracy of a sensor using an optical lever. Furthermore, the amount of z coordinate correction can be determined without using a large-scale device such as a sensor using an optical lever, and defocusing can be easily adjusted.

According to the first embodiment, furthermore, defocusing correction is performed by correcting the z coordinate of the sample 8 without requiring a change in the setting of the optical system. This eliminates the need to adjust the magnification and the rotation angle resulting from the adjustment of the optical system, and to readjust the optical system by adjustment of the magnification and the rotation angle. Therefore, a defocusing can be easily adjusted.

The above described the example in which the inspection apparatus 1 uses the multiple electron-beam MEB. However, the inspection apparatus 1 may use a single electron beam. Such a case uses one electron beam EBA instead of emitting to the sample 8 a plurality of electron beams EBA multiplied by the forming aperture array plate 23 in parallel. Hereinafter, such an electron beam may be referred to as a “single electron beam EBA”.

As shown in FIG. 11, in the case of using a single electron beam EBA, the single electron beam EBA is emitted to the entirety of each rectangular area 83, as shown in FIG. 11. An example of the trajectory of the emission position is the same as in the case of using the multiple electron-beam MEB (FIG. 4), that is, the trajectory of the emission position with respect to each sub rectangular area 85 by the multiple electron-beam MEB has the form expanded to the entirety of the rectangular areas 83.

Also in the case of using the single electron beam EBA, from the electron beam initial position PR (x, y) of the single electron beam EBA and the electron beam position PS (x, y) for each rectangular area 83, the rotation angle θ and the amount of z coordinate correction Δz are acquired.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inspection apparatus comprising:
a stage for a sample to be placed;
an image acquisition circuit configured to acquire a plurality of inspection images based on secondary electrons generated by a plurality of electron beams emitted to a first area of the sample, the first area including a plurality of sub areas;
an estimation circuit configured to estimate an amount of rotation of an array of the plurality of electron beams emitted to the first area based on an amount of misalignment between a plurality of reference images respectively indicative of patterns to be respectively formed in the plurality of sub areas and the plurality of inspection images;
a stage control circuit configured to control, based on the amount of rotation, a focus position of the plurality of electron beams to be emitted to a second area of the sample; and
a comparison circuit configured to compare the plurality of reference images with the plurality of inspection images.

2. The inspection apparatus according to claim 1, wherein:
the image acquisition circuit is configured to sequentially acquire a plurality of inspection images for each one of a plurality of areas based on secondary electrons generated by a plurality of electron beams emitted to the one of the plurality of areas, the plurality of areas being arranged along a first axis of the sample and each including a plurality of sub areas, and the estimation circuit is configured to estimate, for each one of the plurality of areas, the amount of rotation of the array of the plurality of electron beams emitted to the one of the plurality of areas, based on an amount of misalignment between a plurality of reference images respectively indicative of patterns to be respectively formed in the plurality of sub areas of the one of the plurality of areas and the plurality of inspection images.

3. The inspection apparatus according to claim 1, wherein:
the plurality of inspection images are based on secondary electrons generated by the plurality of electron beams respectively emitted to the plurality of sub areas on a one-to-one basis.

4. The inspection apparatus according to claim 3, wherein:
the image acquisition circuit is configured to sequentially acquire a plurality of inspection images for each one of a plurality of areas based on secondary electrons generated by a plurality of electron beams emitted to the one of the plurality of areas, the plurality of areas being arranged along a first axis of the sample and each including a plurality of sub areas, and the estimation circuit is configured to estimate, for each one of the plurality of areas, the amount of rotation of the array of the plurality of electron beams emitted to the one of the plurality of areas, based on an amount of misalignment between a plurality of reference images respectively indicative of patterns to be respectively formed in the plurality of sub areas of the one of the plurality of areas and the plurality of inspection images.

5. The inspection apparatus according to claim 3, wherein:
the estimation circuit is configured to:
estimate a plurality of first positions in the first area to which the plurality of electron beams respectively have reached, based on an amount of misalignment between each one of the plurality of inspection images and one of the plurality of reference images, and
estimate the amount of rotation based on the amount of misalignment between a plurality of initial positions of the plurality of electron beams and the plurality of first positions.

6. The inspection apparatus according to claim 5, wherein:
the image acquisition circuit is configured to sequentially acquire a plurality of inspection images for each one of a plurality of areas based on secondary electrons generated by a plurality of electron beams emitted to the one of the plurality of areas, the plurality of areas being arranged along a first axis of the sample and each including a plurality of sub areas, and
the estimation circuit is configured to estimate, for each one of the plurality of areas, the amount of rotation of the array of the plurality of electron beams emitted to the one of the plurality of areas, based on an amount of misalignment between a plurality of reference images respectively indicative of patterns to be respectively formed in the plurality of sub areas of the one of the plurality of areas and the plurality of inspection images.

7. The inspection apparatus according to claim 5, wherein:
the image acquisition circuit is configured to acquire a plurality of second inspection images based on secondary electrons generated by the plurality of electron beams emitted to a third area of the sample, the third area including a plurality of second sub areas, and
the inspection apparatus further comprises an inspection control circuit configured to estimate the plurality of initial positions of the plurality of electron beams based on an amount of misalignment between a plurality of second reference images respectively indicative of patterns to be respectively formed in the plurality of second sub areas and the plurality of second inspection images.

8. The inspection apparatus according to claim 7, wherein:
the image acquisition circuit is configured to sequentially acquire a plurality of inspection images for each one of a plurality of areas based on secondary electrons generated by a plurality of electron beams emitted to the one of the plurality of areas, the plurality of areas being arranged along a first axis of the sample and each including a plurality of sub areas, and
the estimation circuit is configured to estimate, for each one of the plurality of areas, the amount of rotation of the array of the plurality of electron beams emitted to the one of the plurality of areas, based on an amount of misalignment between a plurality of reference images respectively indicative of patterns to be respectively formed in the plurality of sub areas of the one of the plurality of areas and the plurality of inspection images.

9. The inspection apparatus according to claim 7, wherein:
the image acquisition circuit is configured to acquire the plurality of inspection images based on secondary electrons generated by emitting the plurality of electron beams in such a manner as to scan each of a plurality of third areas of the sample, and
the inspection control circuit is configured to:
acquire a plurality of first rotation amounts of the plurality of inspection images, respectively, from a second center point of a set of a plurality of first center points of the plurality of third areas, a vector from the second center point to each one of the first center points, and the amount of the misalignment; and
estimate the amount of rotation based on an average of the plurality of first rotation amounts.

10. The inspection apparatus according to claim 9, wherein:
the inspection control circuit is configured to:
estimate an amount of defocusing of the first area based on the amount of rotation; and
control the focus position of the plurality of electron beams by changing a position of the stage to such an extent that the amount of defocusing is canceled.

11. An inspection apparatus comprising:
a stage for a sample to be placed;
an image acquisition circuit configured to acquire an inspection image based on secondary electrons generated by an electron beam emitted to a first area of the sample;
an estimation circuit configured to estimate an amount of rotation of the electron beam emitted to the first area based on an amount of misalignment between a reference image indicative of a pattern to be formed in the first area and the inspection image;
a stage control circuit configured to control, based on the amount of rotation, a focus position of the electron beam to be emitted to a second area of the sample; and
a comparison circuit configured to compare the reference image with the inspection image.

12. The inspection apparatus according to claim 11, wherein:
the image acquisition circuit is configured to sequentially acquire a plurality of inspection images for each one of a plurality of areas based on secondary electrons generated by an electron beam emitted to the one of the plurality of areas, the plurality of areas being arranged along a first axis of the sample, and
the estimation circuit is configured to estimate, for each one of the plurality of areas, the amount of rotation of the electron beam emitted to the one of the plurality of areas, based on an amount of misalignment between a reference image indicative of a pattern to be formed in the one of the plurality of areas and the inspection image.

13. An inspection method comprising:
acquiring a plurality of inspection images based on secondary electrons generated by a plurality of electron beams emitted to a first area of a sample, the first area including a plurality of sub areas;
estimating an amount of rotation of an array of the plurality of electron beams emitted to the first area based on an amount of misalignment between a plurality of reference images respectively indicative of patterns to be respectively formed in the plurality of sub areas and the plurality of inspection images;
controlling a focus position of the plurality of electron beams to be emitted to a second area of the sample based on the amount of rotation; and
comparing the plurality of reference images with the plurality of inspection images.

14. The inspection method according to claim 13, wherein:
the acquiring includes sequentially acquiring a plurality of inspection images for each one of a plurality of areas based on secondary electrons generated by a plurality of electron beams emitted to the one of the plurality of areas, the plurality of areas being arranged along a first axis of the sample and each including a plurality of sub areas, and
the estimating includes, for each one of the plurality of areas, the amount of rotation of the array of the plurality of electron beams emitted to the one of the plurality of areas, based on an amount of misalignment between a plurality of reference images respectively indicative of patterns to be respectively formed in the plurality of sub areas of the one of the plurality of areas and the plurality of inspection images.

15. The inspection method according to claim 13, wherein:
the acquiring includes acquiring the plurality of inspection images based on secondary electrons generated by the plurality of electron beams respectively emitted to the plurality of sub areas on a one-to-one basis.

16. The inspection method according to claim 15, wherein:
the estimating includes:
estimating a plurality of first positions in the first area to which the plurality of electron beams respectively have reached, based on an amount of misalignment between each one of the plurality of inspection images and one of the plurality of reference images; and
estimating the amount of rotation based on the amount of misalignment between a plurality of initial positions of the plurality of electron beams and the plurality of first positions.

17. The inspection method according to claim 15, further comprising:
acquiring a plurality of second inspection images based on secondary electrons generated by the plurality of electron beams emitted to a third area of the sample, the third area including a plurality of second sub areas; and
estimating the plurality of initial positions of the plurality of electron beams based on an amount of misalignment between a plurality of second reference images respectively indicative of patterns to be respectively formed in the plurality of second sub areas and the plurality of second inspection images.

18. The inspection method according to claim 17, further comprising:
acquiring the plurality of inspection images based on secondary electrons generated by emitting the plurality of electron beams in such a manner as to scan each of a plurality of third areas of the sample; and
acquiring a plurality of first rotation amounts of the plurality of inspection images, respectively, from a second center point of a set of a plurality of first center points of the plurality of third areas, a vector from the second center point to each one of the first center points, and the amount of the misalignment, wherein
the estimating includes estimating the amount of rotation based on an average of the plurality of first rotation amounts.

19. The inspection method according to claim 18, further comprising:
estimating an amount of defocusing of the first area based on the amount of rotation, wherein
the controlling includes changing a position of a stage to such an extent that the amount of defocusing is canceled.
